(19) United States
(12) Patent Application Publication
(10) Pub. No.: US 2008/0117464 A1
(43) Pub. Date: May 22, 2008

(54) Method and system for reducing auto-moire artifacts in periodic halftone screening

(75) Inventor: Kenneth R. Crounse, Somerville, MA (US)

Correspondence Address: BREINER & BREINER, L.L.C., P.O. BOX 320160, ALEXANDRIA, VA, 22320-0160, US

(73) Assignee: Monotype Imaging, Inc., Woburn, MA (US)

(21) Appl. No.: 11/601,786

(22) Filed: Nov. 20, 2006

(51) Int. Cl. G06K 15/00

(52) U.S. Cl. 358/3.03

(57) ABSTRACT

The design of periodic screens for halftone patterns is based upon a series of constrained optimization problems. For each of a number of input levels, a pattern is found that minimizes a cost function. The cost function is a spatial-frequency weighted difference between an ideal, continuous-space pattern and a predicted reconstructed pattern. The frequency weighting is a parameterized trade-off between the preservation of periodic components and the introduction of non-harmonic components.

### FIELD OF INVENTION

The present invention relates to the reproduction of multi-tone, e.g. grayscale or color, images on digital output devices, such as printers, and more particularly to the generation of periodic screens that reduce auto-moiré artifacts in the conversion of a multi-tone image to a halftone image.

### BACKGROUND OF THE INVENTION

To print an original image containing continuous or a large number of discrete gray shades on a digital printer the output of which is limited to a lesser number of discrete levels of intensity, the original image is converted into a halftone image comprised of dots or lines of varying size and shape. Typically, a screening process is employed to perform this conversion. The screen consists of an array of halftone cells, each of which represents a block of continuous tone in the original image as a single dot of variable size and/or shape, which on average will reproduce the same intensity as the original. Each halftone cell comprises individual pixels having respective values against which the input pixels of the original image are compared. The halftone screening process includes a screen threshold generating phase which can typically be done in advance to use on any input image, and a comparison phase in which the input image is compared to the values in the screen threshold. According to one typical convention, for each comparison, if the intensity of the pixel in the original image is less than the value in the screen pattern, a mark is printed. If the intensity of the image pixel is greater than or equal to the screen cell value, no corresponding mark is printed. When the output device can produce marks of several possible intensities, or levels, multi-level halftone patterns need to be generated. There are many possible representations. One of the most general is to generalize the threshold method described above by having a number of thresholds per pixel that is one less than the number of the output levels.

This halftoning process can produce artifacts in the resulting printed image. One artifact that can occur is auto-moiré patterns. In general, if the displacement of halftone dots in a screen has an integral relationship to the spacing of marking positions in the printer, auto-moiré patterns do not occur. However, when the distance between halftone dot centers has a non-integral relationship to the printer grid, moiré-like artifacts may appear. This can occur in periodic screening or non-periodic clustered dot screening when halftone dots have centers with differing relative phase to the output pixel grid. To avoid this problem in the past, halftone screens with non-integral displacements were not used in many situations. While this constraint does not present significant limitations at higher printing resolutions, e.g. above 1200 dpi, for lower printing resolutions the number of available screen designs is quite limited. Unfortunately, however, the screening angles and frequencies used in some applications typically require non-integral displacements, especially when trying to cancel four color moiré. Consequently, the designer was forced to make a tradeoff between inter-channel artifacts and the elimination of auto-moiré artifacts.

### SUMMARY OF THE INVENTION

The moiré-like artifacts resulting from non-integral halftone screens can be understood as a consequence of the phenomenon known as aliasing. By using signal processing methods, it can be-shown that such artifacts are not a mandatory consequence of non-integral displacement screening. The auto-moiré effect can be significantly reduced, and functionally eliminated in many practical situations, by designing an appropriate set of periodic screen patterns for the halftoning operation.

As disclosed hereinafter, periodic screen design is approached as a series of constrained optimization problems. For each of a number of input levels, a pattern is found that minimizes a cost function. Although not mandatory, the approach preferably obeys a stacking constraint imposed by previously solved patterns, as well as the dynamic range of the output device. The cost function is a spatial-frequency weighted difference between an ideal, continuous-space pattern and a predicted reconstructed pattern. The reconstruction need not be a prediction of the final output of the printing system, but only at some stage after reconstruction to continuous space. The frequency weighting is a parameterized trade-off between the preservation of periodic components of the ideal screen pattern and the introduction of low spatial frequency components.

As further features, an output quantization process, and conversion to the conventional threshold array representation of a halftone screen, are also provided.

The disclosed technique can be used in conjunction with a frequency-modulated dither pattern for highlights or shadows. For example, in such a case the halftone pattern can be found by the disclosed technique for which all halftone dots are of the desired minimal size. This pattern is then masked by the dither pattern.

The invention is applicable in relation to color or grayscale image output devices. Accordingly, while grayscale may be referred to for ease of description, the invention is not to be limited thereto.

### BRIEF DESCRIPTION OF THE DRAWINGS

FIG. 1 is a general block diagram of a system implementing the principles of the present invention;

FIG. 2 is an illustration of an ideal pattern for a given grayscale level;

FIG. 3 is an illustration of the effects of aliasing when a conventional linear anti-aliasing method is applied to the pattern of FIG. 2;

FIG. 4 is a flowchart of one embodiment for generating optimized halftone patterns in accordance with an embodiment of the invention;

FIG. 5 is a more detailed flowchart of the optimization procedure in a preferred embodiment of the invention; and

FIG. 6 is a flowchart of another embodiment for generating optimized halftone patterns in accordance with the invention.

### DETAILED DESCRIPTION

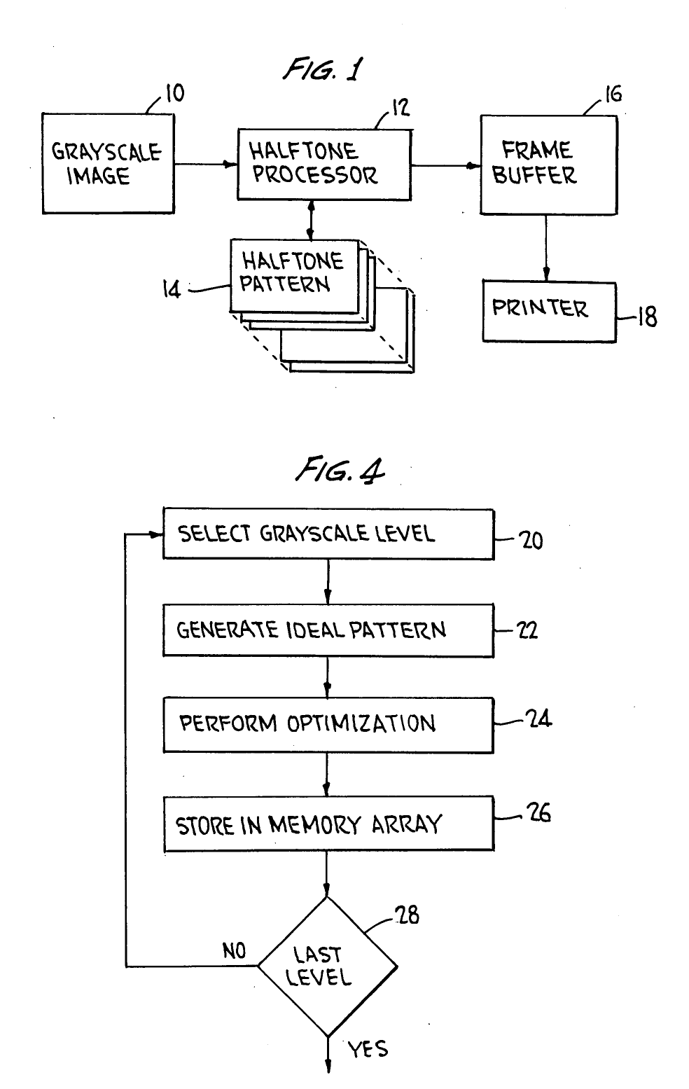

An exemplary printing system, in which the principles of the present invention can be implemented, is illustrated in FIG. 1. Each pixel of an image 10 to be reproduced is sampled, and the intensity of the sample is provided to a halftone processor 12. The intensity values may be provided from a scanner, if the original image is printed on paper, or directly generated by a computer. In an exemplary system, the intensity values might be 8-bit values, representative of 256 grayscale levels. In response to the receipt of each intensity value, the halftone processor 12 accesses a halftone pattern 14 that corresponds to the received intensity value. Thus, for example, if the range of intensity values covers 256 grayscale levels, i.e. 8-bit intensity values, there will be 256 different halftone screen patterns 14, one for each distinct grayscale level. Each screen pattern indicates whether a mark (or level of a mark) is to be printed at a location corresponding to the pixel in the original image 10 whose intensity value was received. The halftone pattern is not typically stored for a whole page, but defined on a smaller tile (also called “array ”) that is applied periodically. To calculate the pixel location in the tile its coordinates must be taken modulus to tile size. The halftone processor sends data to a frame buffer 16, which stores data indicating whether a mark (or level) is to be printed at that location. The data stored in the frame buffer essentially comprises a bit-map image of the page. This data is then sent to the printer 18, to produce the final result. Alternatively, if the halftone patterns obey the stacking constraint, they may be stored implicitly as threshold arrays, in which case the halftone processor applied the appropriate thresholding to generate the pixel.

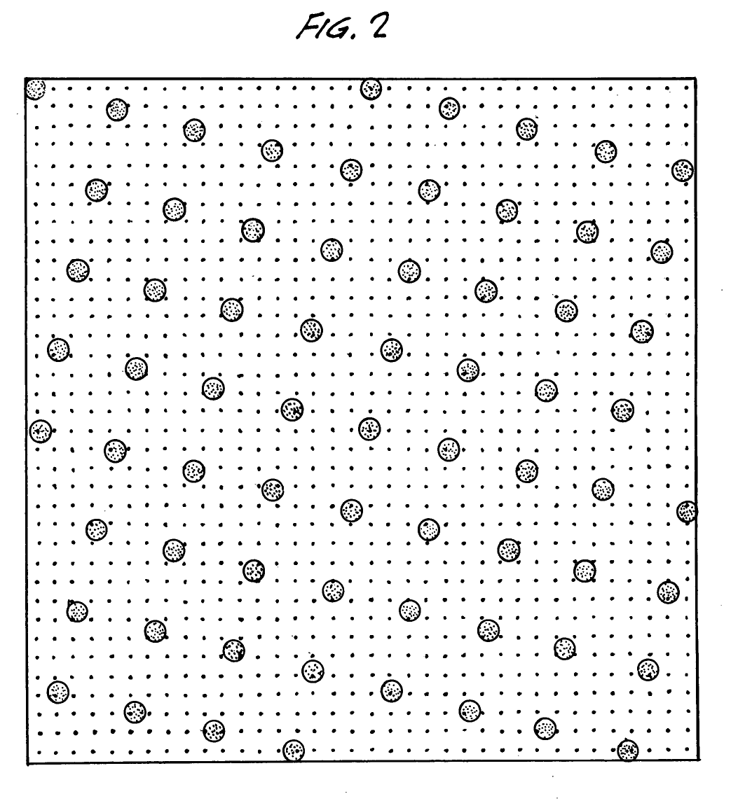

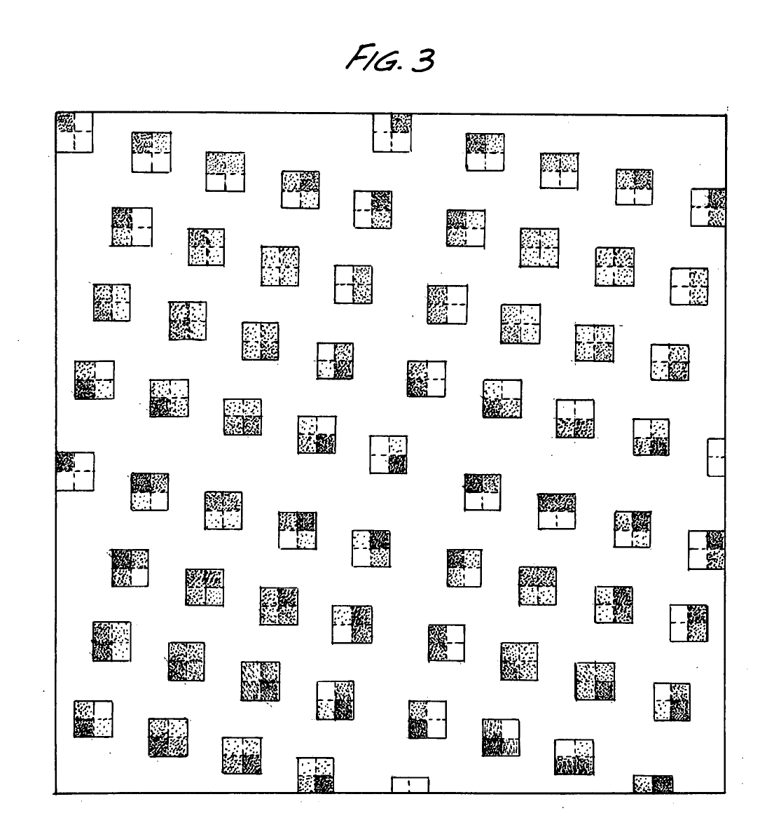

The present invention is particularly directed to the halftone patterns 14. FIG. 2 illustrates an ideal halftone pattern for grayscale level 243, where a grayscale value of 255 represents pure white. The larger dots depict the halftone dots which would ideally be printed, and the smaller dots represent the sampling grid of the output device, e.g. the pixel positions of printer 18. The illustrated pattern represents a screen oriented at an angle of about 14 degrees relative to the sampling grid of the printer. As can be seen, some of the ideal dots in the pattern are in alignment with the points in the sampling grid. However, other dots in the pattern are located between sampling points. In other words, the displacement of the dots in the pattern has a non-integral relationship to the spacing of the points in the sampling grid. Consequently, when creating a screen pattern for a bi-level output device, the actual dot location will need to be shifted to a real output position, introducing a non-harmonic component to the pattern. When creating a screen pattern for an output device having multi-level printing capabilities, an anti-aliasing method can be employed to “spread” these non-aligned dots over two or more of the sampling points in an attempt to reduce this effect. FIG. 3 illustrates the result when this occurs. As can be seen, the dots that are aligned with the sampling points are printed at full darkness, whereas the dots which are located between sampling points are printed at intermediate values. For instance, the center of the pattern comprises a 3×3 block of dark pixels which is surrounded by lighter dots. However, if the aliasing is not completely eliminated, on a larger scale, these areas of varying dark and light intensity can create a moiré-like effect in the resulting image. Most linear anti-aliasing methods will preserve the average darkness of each halftone dot in the pattern. However, if any aliased frequencies are present, moiré-like artifacts can still emerge due to nonlinearities in the printing system. Although it is possible to apply a perfect anti-aliasing filter to the continuous space pattern, the result will not be a valid halftone pattern since the resulting data will in general exceed the dynamic range bounds of the output device. Furthermore, it would require that the halftone image samples be continuous values instead of a discrete number of levels.

To address this problem, the present invention generates halftone patterns that, under reconstruction, are as periodic as possible in the screen frequency and its harmonics, using constrained convex optimization techniques. The optimization attempts to minimize the costs associated with the trade-off between preservation of the ideal pattern on one hand, and elimination of non-harmonics that result from aliasing on the other hand. The result under construction will be dot shapes as close to the ideal as possible, while making each dot as nearly identical to the others as possible. For the method to work, the reconstruction function to continuous space need not be a complete model for the output device if the device can be reasonably assumed to be a space invariant nonlinear system, since a space-invariant nonlinear operation on a periodic function will still be periodic with the same fundamental, and the dots will remain identical to each other, though likely altered in shape.

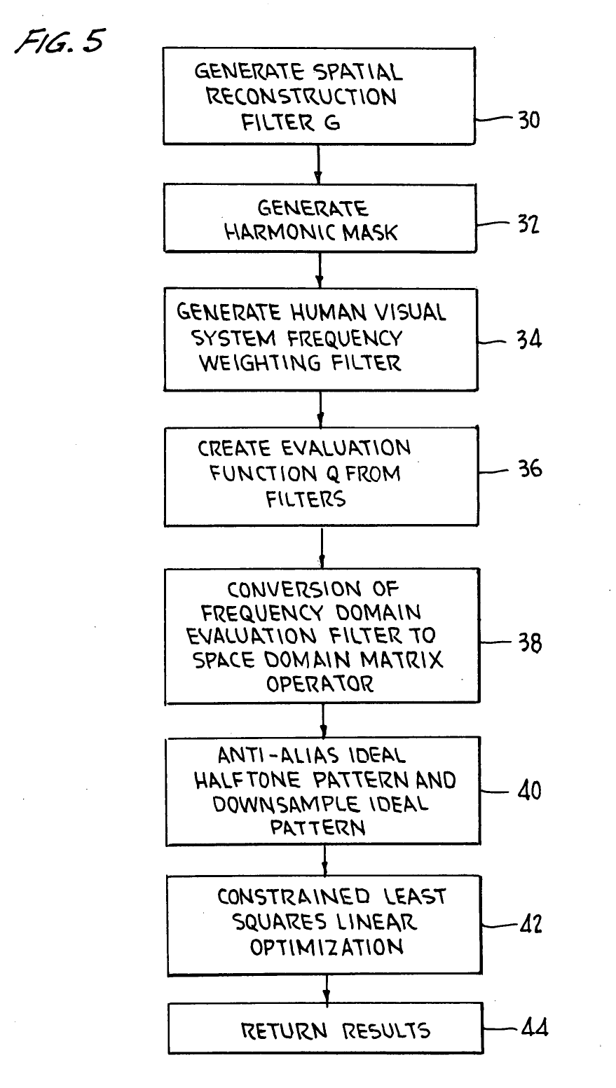

A general overview of the procedure for generating the screens is illustrated in the flow chart of FIG. 4. As a first step, a desired grayscale level is selected, at step 20. The selection of the levels can proceed in any desired order. For example, it can proceed linearly from 0 to 255. In one embodiment of the invention, the process uses a mid-range selection approach, starting with the middle grayscale level 128, followed by the two levels halfway between that level and the end points, i.e. 64 and 192, and then the levels 32, 96, 160 and 224, etc. For each chosen level, an ideal periodic halftone pattern is obtained at step 22. The ideal pattern is one chosen by an expert for the output system under consideration. In practice a continuous space description is not used, but rather a significantly over-sampled pattern should be used. For example, an oversampling of 17× is used to produce the ideal dots in FIG. 2. This step can be performed by means of any known technique. For instance, one program that can generate the pattern for each level is the Agfa Balanced Screening (ABS). Alternatively, the pattern can be mathematically generated from a spot function description.

At the next step 24, an optimization is performed on the ideal pattern. In practice, the optimization applies filtering techniques to reconstruct onto the oversampled space the trial pattern specified on the sampling grid of the output device. Then, differences from the ideal pattern in terms of weighted non-harmonic and harmonic components are determined. These differences are then used to update the trial halftone pattern in a manner that obeys other constraints. The result is to eliminate, or at least reduce, the non-harmonic components of the dots produced by the pattern, while maintaining the overall shape of the dots, to the extent possible. After the pattern has been optimized, it is stored in memory at step 26. The patterns can be stored in the form of a 3-dimensional array of values. One dimension of the array has a size equal to the number of patterns, e.g. 256 in the example given above. The other two dimensions have sizes that correspond to tile size of the screen. For example, the array might have a size of 18×18×256.

After the optimized pattern has been stored in the array, a determination is made at step 28 whether there are additional grayscale levels to be processed. If so, the procedure returns to step 20 to select the next level and repeat steps 22-26. In one embodiment of the invention, each grayscale level can be processed independently of every other level. In another embodiment, it may be preferable to impose a stacking constraint, such that each successively darker level can only add dots to the patterns of lighter levels, and not remove any that are already present.

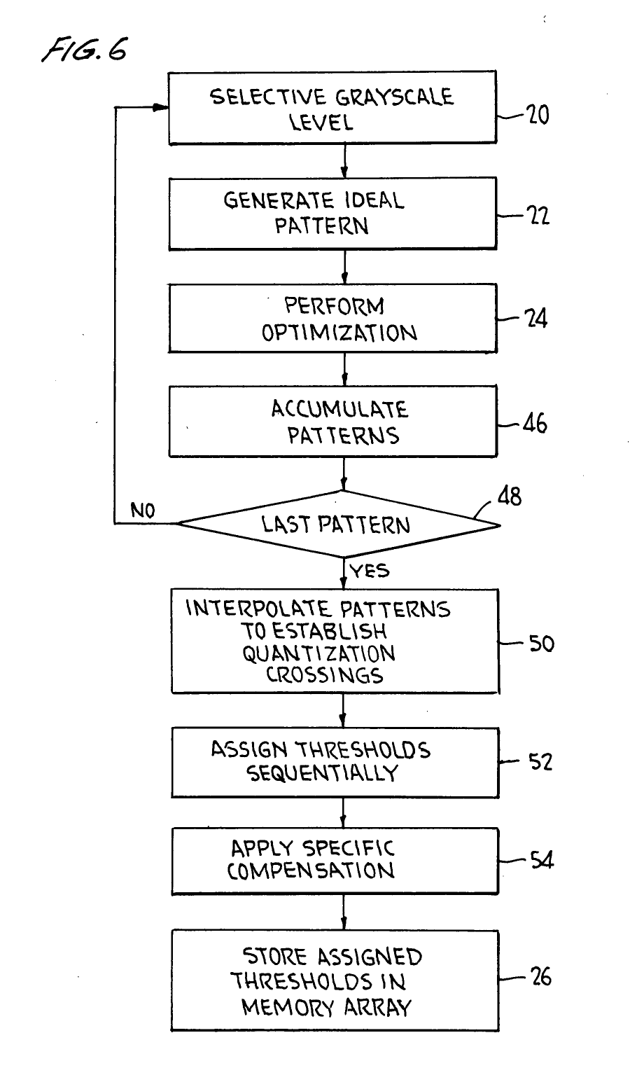

The optimization that is performed in step 24 can be carried out with any of a variety of known techniques for doing so. In one embodiment of the invention, a constrained least squares linear optimization of all Fourier components is employed to accomplish this step. The flowchart of FIG. 5 illustrates one example of such an optimization process. The first step 30 of the process is to generate a spatial reconstruction filter G. This filter is, in essence, a guess at what the reconstructed pattern of a single “on” pixel will look like. In its simplest form it is a simple two-dimensional linear low pass filter, such as a Gaussian blur with a user-selected standard deviation. The exact model will depend on the output device. In the special case that the reconstruction is nearly bandlimited, the optimization can take place in the space of the output sampling grid by also ideally bandlimiting the ideal pattern and subsampling, which simplifies and speeds-up the calculations during optimization. The visual result of this step is a round dot that is blurred by a Gaussian blur to approximate the physical effects which produce the optical exposure profile on the organic photoconductor of an electrophotographic laser printer for example. If there is a nonlinear relationship between the halftone level and the discrete input to the reconstruction model, for example due to the pulse width modulator characteristics, it is ideally inverted after the optimization so that the linear least-squares formulation of the optimization problem is maintained.

The next step 32 is to generate a harmonic mask. This mask is a frequency domain mask defined by 2-dimensional, possibly non-orthogonal, comb function selecting the fundamental frequencies of the screen pattern and their harmonics. At step 34, a human visual system frequency weighting filter is generated (i.e., a contrast sensitivity function). The filter(s) is(are) combined with the harmonic mask to create in step 36, a frequency weighting evaluation function for the error image, i.e., the creation of evaluation function Q from the filters. This frequency weighting uses a user-selectable trade-off factor, e.g. 20% or 50%, that determines the extent to which screen fundamental and harmonics are preserved compared to the introduction of visible artifacts. In terms of human perception, low frequency aliasing is much more noticeable than high-frequency effects.

The optimization is most easily carried out in the spatial domain since the bounds apply to space-domain variables. Therefore, at step 38 the two-dimensional frequency domain evaluation filter is converted to a space domain matrix operator. At step 40, preferably the ideal halftone pattern is ideally anti-aliased and then downsampled to obtain an ideal anti-aliased pattern, if the optimization will be performed in the baseband only. Step 40 is not required but provides simplification in practice making the process faster. Accordingly, step 40 is advantageous and preferred. Then, at step 42, a constrained least squares linear optimization is performed. In this optimization, the differences between the ideal downsampled pattern obtained at step 40 and the reconstructed estimate using G are convolved with the frequency weighted evaluation function Q are minimized, subject to the inequality constraints of the lower and upper bounds of the system, e.g. values of 0 and 255 and possibly equality bounds preserving the average value of the pattern. It is well known that there are efficient algorithms that can find a solution corresponding to the global minimum of such a convex problem. Optimization herein preferably employs the Matlab function “lsqlin” based on pre-conditioned conjugate gradients, but many gradient descent type algorithms are possible. The values corresponding to the minimum difference are then returned at step 44.

Within this overall framework, a number of variations are possible. For instance, in the basic approach the number of patterns to be generated is equal to the number of quantized grayscale levels, e.g. 256. However, it might be desirable to generate a greater number of patterns, to provide better compensation for the physical attributes of the printing process. To accommodate the effects of physical or optical dot-gain, for example, it may be preferable to have more patterns available for selection at lighter levels than at darker levels. In this case, more patterns can be generated, at least at the lighter levels, and then a subset of those patterns can be selected so that the tone scale is evenly spaced on a particular output device. Alternatively, using known characteristics of a device, a non-uniform distribution of the 256 levels can be pre-determined to give the desired tone reproduction curve.

Another method is to convert the patterns into a “full-range” threshold array. Such an array has a unique threshold in each position. For example, if the threshold array is 18×18 in size with 15 thresholds per position, there would need to be 18×18×15=4860 unique threshold values. The advantage of such a representation is that it can be accurately linearized for a particular device by a compensation procedure. After converting thresholds to 8-bits, the resulting storage of the threshold representation is also less than storing all the patterns. Such an embodiment of the invention is represented in the flowchart of FIG. 6. Steps 20-24 are performed in the same manner as in the basic procedure of FIG. 4. After step 24, the resulting patterns are not immediately stored in the 3-dimensional array, or other suitable data structure, for retrieval by the halftone processor. Rather, each pattern is accumulated, in a temporary buffer or the like, at step 46. A number of patterns are generated and accumulated which is greater than the number of grayscale levels, e.g. 512 patterns.

After all of the patterns have been generated, as determined at step 48, the patterns are interpolated to establish quantization crossings in step 50. The threshold values are generated by sequentially stepping through the patterns and determining the order in which pixels first cross an output level. The crossing level can be estimated from interpolation of the values in the patterns of known levels. The thresholds can be assigned sequentially in the crossing order 52. To produce a smooth gradation with a smaller number of unique thresholds, e.g. 256, compensation that is specific to a particular print engine can be implemented at step 54. Thus, for example, if the print engine produces very small dots at lighter grayscale levels, the halftone patterns assigned to those levels can be chosen from patterns having higher densities by a non-uniform quantization of the thresholds.

Once these procedures have been completed, the assigned thresholds are stored in the threshold array at step 26.

In a variation of this embodiment, output levels of the halftone patterns can be fixed to quantization values during the optimization, if they are known. This will result in reduced quantization error. One method by which this can be done is to solve the least squares optimization problem many times. Each time, one or more pixels that are closest to a quantized output level are quantized to that level and then fixed, and the remaining pixels are re-optimized, until all pixels have been determined. If converting to full-range thresholds, only every other level needs to be quantized, with intermediate levels being used for accurate interpolation.

From the foregoing, it can be seen that the present invention alleviates the limitation on the available halftone patterns that can be used when printing grayscale images in a digital imaging process. By using optimization techniques, halftone patterns are produced that approach truly periodic patterns, and thereby reduce the moiré-like artifacts. While the patterns obtained by means of the foregoing embodiments can be used with printers of any resolution, their benefits are particularly noticeable with printers having resolutions of 1200 dpi or less.

The methods described herein can be applied to other problems in halftoning in a straightforward manner. For example, other forms of clustered dot screening could benefit from the optimization approach to anti-aliasing. One example are “green noise” halftones in which halftone dots are spaced in a pleasing quasi-periodic manner. By modification of the comb component of the evaluation filter, the same approach can be used to reduce low frequency components in the pattern.

The embodiments disclosed herein are illustrative of the principles that underlie the invention, and not intended to be a limitation thereof. For instance, while a particular optimization technique has been disclosed in detail, it will be appreciated that other known optimizations can be employed to achieve the same, or similar, results. For example, cost functions based on minmax or sum of absolute errors, or goal attainment approaches, and optimization methods based on cellular neural networks, simulated annealing, or direct binary searching. Such methods may especially provide a benefit if the halftone values are significantly quantized, e.g., 1 or 2 bits, so that quantization error becomes dominant and the problem cannot be approximated by a convex optimization. The scope of the invention is set forth in the accompanying claims, rather than the foregoing description, and all equivalents of the described embodiments are intended to be embraced therein.

What is claimed is:

1. A method for generating halftone patterns for reproduction of multi-tone images, comprising steps
(a) selecting desired levels for a tone to be reproduced;
(b) generating for each of said levels an ideal halftone pattern;
(c) optimizing based on said ideal halftone patterns; and
(d) storing optimized patterns obtained in a computer-readable medium for access during conversion of a multi-tone image to a halftone image for reproduction.

2. The method of claim 1, wherein said optimizing of (c) is conducted for each level of said levels iteratively.

3. The method of claim 2, wherein said optimizing of (c) for a level of said levels is also based on a pattern resulting from at least one previous level.

4. The method of claim 1, wherein said optimizing of (c) is conducted by minimizing a cost function.

5. The method of claim 1, wherein said optimizing of (c) is conducted by an optimization algorithm.

6. The method of claim 1, wherein said optimizing of (c) iteratively reduces differences.

7. The method of claim 1, wherein said optimizing of (c) does not find a global minimum.

8. The method of claim 1, wherein said optimizing of (c) comprises filtering to reconstruct a trial pattern on a sampling grid to determine differences from said ideal halftone pattern as weighted non-harmonic components and weighted harmonic components.

9. The method of claim 8, wherein said optimizing reduces the differences between said trial pattern as reconstructed and said ideal halftone pattern.

10. The method of claim 8, wherein said filtering is performed with a filter that includes a model of a human visual system.

11. The method of claim 10, wherein said filter comprises a low-pass filter.

12. The method of claim 1, wherein said optimized patterns are quantized prior to storing said optimized patterns.

13. The method of claim 1, wherein said optimized patterns are quantized during said optimizing of (c).

14. The method of claim 1, wherein a number of halftone patterns greater than a number of multi-tone levels to be reproduced are subjected to said optimizing, and further including a step of assigning selected ones of optimized patterns to respective levels.

15. The method of claim 1, further comprising a step of estimating, based on said optimized halftone patterns, intermediate halftone patterns for at least one level not subjected to said optimizing.

16. The method of claim 1, wherein said optimized patterns are converted into a threshold array.

17. A system for converting a multi-tone image to a halftone image for reproduction, comprising:
a memory storing a plurality of halftone patterns, each of which is generated by obtaining a halftone pattern for a tone to be reproduced, by generating an ideal halftone pattern for said tone, and optimizing based on said ideal halftone patterns;
a halftone processor that receives a value indicative of a level of a pixel in an image to be reproduced and, in response thereto, retrieves a pattern from said memory that relates to the level received, and outputs a signal indicating whether a mark is to be printed at a location corresponding to said pixel; and
a frame buffer for storing signals output by said halftone processor.

18. The system of claim 17, wherein the halftone patterns are stored as represented by threshold arrays.

19. The system of claim 17, further comprising a filter to reconstruct a trial pattern on a sampling grid to determine differences from said ideal halftone pattern as weighted non-harmonic components and weighted harmonic components.

20. The system of claim 19, wherein said differences between said trial pattern as reconstructed and said ideal halftone pattern are reduced during said optimizing.

21. The system of claim 19, wherein said filter includes a model of a human visual system.

22. The system of claim 21, wherein said halftone pattern is convolved with said filter.

23. The system of claim 21, wherein said filter comprises a low-pass filter.
